(19) United States
(12) Patent Application Publication
(10) Pub. No.: US 2020/0315141 A1
(43) Pub. Date: Oct. 8, 2020

(54) INFORMATION PROCESSING APPARATUS AND INFORMATION PROCESSING METHOD

(71) Applicant: Panasonic Intellectual Property Management Co., Ltd., Osaka (JP)

(72) Inventors: Naotaka KUSUI, Fukuoka (JP); Katsumi KOMATSU, Fukuoka (JP); Shinji FUKUDA, Fukuoka (JP); Katsuhiro HIRAI, Fukuoka (JP)

(21) Appl. No.: 16/837,192

(22) Filed: Apr. 1, 2020

(30) Foreign Application Priority Data
Apr. 2, 2019 (JP) 2019-070551

(51) Int. Cl. A01K 29/00; G10L 17/26; G06K 9/00

(52) U.S. Cl. CPC A01K 29/005; G06K 9/00362; G10L 17/26

(57) ABSTRACT

An information processing system includes: a state determiner that determines a state of an animal using a captured image of the animal; a feeling determiner that determines a feeling of the animal corresponding to the state of the animal determined by the state determiner, on the basis of a notification wording DB indicating a relationship between the state and the feeling of the animal; and a notification processor that notifies user terminal 4 of a wording indicating the feeling of the animal determined by the feeling determiner.

### CROSS REFERENCE TO RELATED APPLICATIONS

This application is entitled to claim the benefit of Japanese Patent Application No. 2019-070551, filed on Apr. 2, 2019, the disclosure of which including the specification, drawings and abstract is incorporated herein by reference in its entirety.

### TECHNICAL FIELD

The present disclosure relates to an information processing apparatus and an information processing method.

### BACKGROUND ART

Recently, a mechanism for deepening the relationship between an owner and a pet has been provided. Patent Literature (hereinafter, referred to as “PTL”) 1 discloses a mechanism in which the state of a pet, such as a behavior, feeling, and health of the pet is determined using data detected by a sensor apparatus worn by the pet, an utterance of the pet corresponding to the determined state of the pet is obtained from an utterance DataBase (DB), and the utterance is transmitted to a specific user on an interactive SNS.

### CITATION LIST

### Patent Literature

PTL 1

Japanese Patent Application Laid-Open No. 2016-146070

### SUMMARY OF INVENTION

### Technical Problem

However, the mechanism for which pets are to wear the sensor apparatus is stressful for the pets. In addition, this mechanism is expensive for the owner because the number of sensor apparatuses increases as the number of pets increases.

Non-limiting examples of the present disclosure contribute to providing a technique for determining the state of a pet without any sensor apparatus worn by the pet.

### Solution to Problem

An information processing apparatus according to one embodiment of the present disclosure includes: a state determiner that determines a state of an animal using a captured image of the animal; an feeling determiner that determines an feeling of the animal corresponding to the state of the animal determined by the state determiner, the feeling determiner determining the feeling of the animal on a basis of information indicating a relationship between the state and the feeling of the animal; and a notification processor that notifies a terminal of a wording indicating the feeling of the animal determined by the feeling determiner.

Note that these generic or specific aspects may be achieved by a system, an apparatus, a method, an integrated circuit, a computer program, or a recoding medium, and also by any combination of the system, the apparatus, the method, the integrated circuit, the computer program, and the recoding medium.

### Advantageous Effects of Invention

According to one example of the present disclosure, it is possible to determine the state of the pet without any sensor apparatus worn by the pet.

Additional benefits and advantages of one example of the present disclosure will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an exemplary configuration of an information processing system according to Embodiment 1;

FIG. 2 illustrates an exemplary configuration of a monitoring apparatus according to Embodiment 1;

FIG. 3 illustrates an exemplary configuration of a server apparatus according to Embodiment 1;

FIG. 4 illustrates an exemplary configuration of a user terminal according to Embodiment 1;

FIG. 5 illustrates exemplary functions of the server apparatus according to Embodiment 1;

FIG. 6A illustrates Example 1 of audio data according to Embodiment 1

FIG. 6B illustrates Example 2 of the audio data according to Embodiment 1;

FIG. 7 illustrates an example of a notification wording DB according to Embodiment 1;

FIG. 8 is a flowchart illustrating an exemplary operation of the server apparatus according to Embodiment 1;

FIG. 9 illustrates exemplary functions of a server apparatus according to Embodiment 2;

FIG. 10 is an explanatory view for explaining processing example 1 of a monitoring-apparatus controller according to Embodiment 2;

FIG. 11 is an explanatory view for explaining processing example 2 of the monitoring-apparatus controller according to Embodiment 2;

FIG. 12 illustrates an exemplary configuration of an information processing system according to Embodiment 3;

FIG. 13 illustrates an exemplary configuration of an information processing system according to Embodiment 4;

FIG. 14 illustrates an exemplary configuration of an information processing system according to Embodiment 5;

FIG. 15 illustrates an example of a notification wording DB according to Embodiment 5; and

FIG. 16 is an explanatory view for explaining an exemplary operation of a user terminal according to Embodiment 6.

### DESCRIPTION OF EMBODIMENTS

Embodiments of the present disclosure will be described in detail below with appropriate reference to the accompanying drawings. However, any unnecessarily detailed description may be omitted. For example, any detailed description of well-known matters and redundant descriptions on substantially the same configurations may be omitted. This is to avoid the unnecessary redundancy of the following description and to facilitate understanding by those skilled in the art.

It is to be noted that the accompanying drawings and the following description are provided to enable those skilled in the art to fully understand this disclosure, and are not intended to limit the claimed subject.

(Embodiment 1)

### <System Configuration>

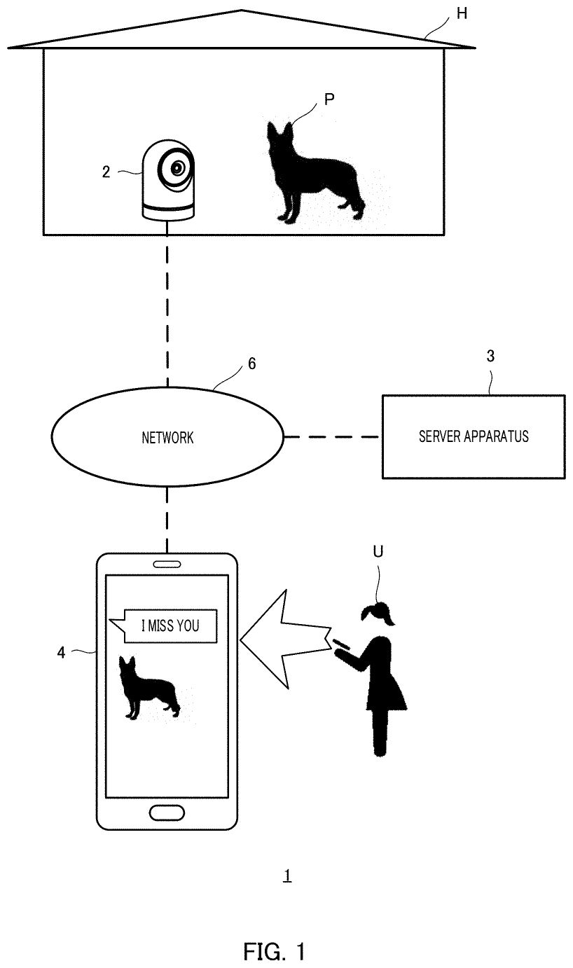

FIG. 1 illustrates an exemplary configuration of an information processing system according to Embodiment 1.

As illustrated in FIG. 1, information processing system 1 includes monitoring apparatus 2, server apparatus 3, and user terminal 4. Monitoring apparatus 2, server apparatus 3, and user terminal 4 can transmit and receive data to and from one another through network 6. Network 6 may at least partially be wired and/or wireless, or Wide Area Network (WAN) and/or Local Area Network (LAN). Network 6 may at least partially be the Internet.

Monitoring apparatus 2 is installed in house H, for example, and monitors pet P. Monitoring apparatus 2 includes a visible light camera and a microphone. Monitoring apparatus 2 captures an image of the figure of pet P with the visible light camera and generates image data. Monitoring apparatus 2 picks up a sound produced by pet P by the microphone and generates audio data. Monitoring apparatus 2 transmits the image data and the audio data to server apparatus 3 through network 6. Monitoring apparatus 2 may be called a pet camera.

Server apparatus 3 determines the feeling of pet P on the basis of the image data and audio data received from monitoring apparatus 2 and generates information indicating the feeling of pet P (hereinafter referred to as “feeling information”). Server apparatus 3 specifies the notification wording corresponding to the feeling information of pet P. Server apparatus 3 transmits the image data and the notification wording to user terminal 4 of user U, who is the owner of pet P.

User terminal 4 displays the image data and the notification wording received from server apparatus 3. It is thus possible for user U to know the situation and feeling of pet P in house H. This will be described in detail below.

<Configuration of Monitoring Apparatus>

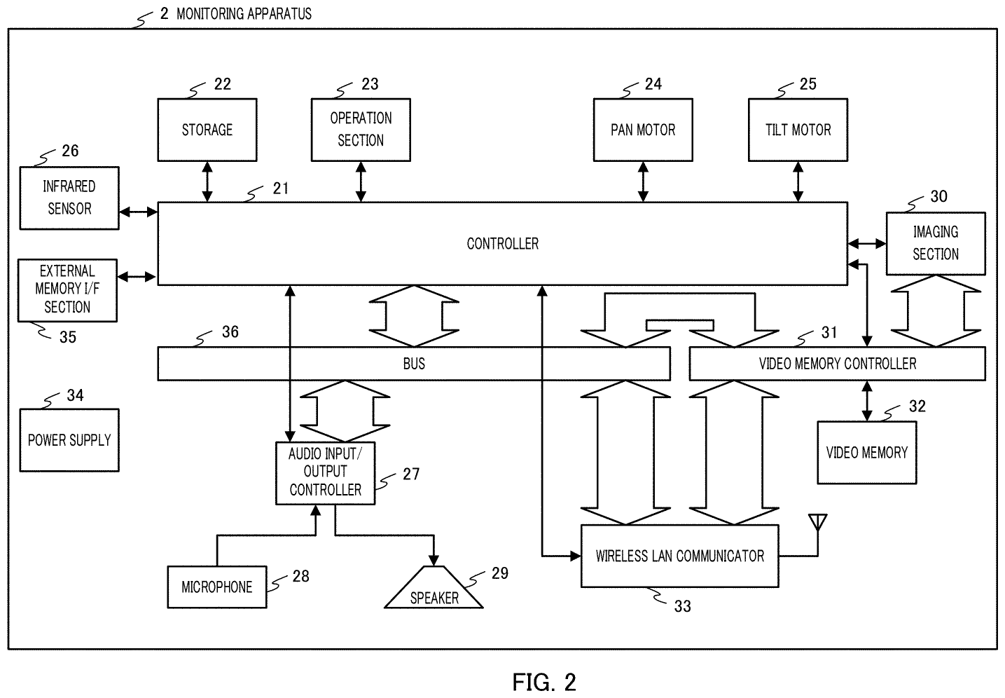

FIG. 2 illustrates an exemplary configuration of monitoring apparatus 2.

As illustrated in FIG. 2, monitoring apparatus 2 includes controller 21, storage 22, operation section 23, pan motor 24, tilt motor 25, infrared sensor 26, audio input/output controller 27, microphone 28, speaker 29, imaging section 30, video memory controller 31, video memory 32, wireless LAN communicator 33, power supply 34, external memory Interface (I/F) section 35, and bus 36.

Controller 21 controls monitoring apparatus 2. Controller 21 may be composed of a Central Processing Unit (CPU).

Storage 22 stores therein a program for operation of controller 21. Storage 22 also stores therein data for calculation processing by controller 21, data for control of each section by controller 21, or the like. Storage 22 may be composed of a storage apparatus such as a Random Access Memory (RAM), a Read Only Memory (ROM), a flash memory, and a Hard Disk Drive (HDD).

Operation section 23 is composed of a button or the like that can receive a user operation. Operation section 23 outputs a signal corresponding to the user operation to controller 21.

Pan motor 24 is a motor that drives imaging section 30 in the pan direction on the basis of the control of controller 21. Tilt motor 25 is a motor that drives imaging section 30 in the tilt direction on the basis of the control of controller 21.

Infrared sensor 26 is, for example, a Passive Infra-Red (PIR) sensor. For example, infrared sensor 26 detects a pet.

Audio input/output controller 27, microphone 28, and speaker 29 perform audio input/output from or to the outside.

Imaging section 30 includes a lens and an imaging element. The imaging element is an image sensor such as a Charged Coupled Device (CCD), a Complementary Metal Oxide Semiconductor (CMOS), or the like. Imaging section 30 has a mechanism allowing movement in the pan direction and the tilt direction. Pan motor 24 and tilt motor 25 allows imaging section 30 to move in the pan direction and the tilt direction, respectively.

Video memory controller 31 temporarily buffers (stores) in video memory 32 the signal of a sound (audio data) collected by microphone 28 together with the image data output from imaging section 30.

Wireless LAN communicator 33 is wirelessly connected to a router (not illustrated) using a wireless communication system such as Wi-Fi (registered trademark), for example. Wireless LAN communicator 33 reads the image data (including the audio data) stored in video memory 32 via video memory controller 31. Wireless LAN communicator 33 transmits the read image data to server apparatus 3 via the router.

Power supply 34 supplies necessary power to each section of monitoring apparatus 2. An external memory such as a USB memory or an SD card (registered trademark) is attached to and detached from external memory I/F section 35. When the pet is detected by infrared sensor 26, controller 21 may cause imaging section 30 to start capturing an image and may store, in the external memory, the image data of imaging section 30 stored in video memory 32.

<Configuration of Server Apparatus>

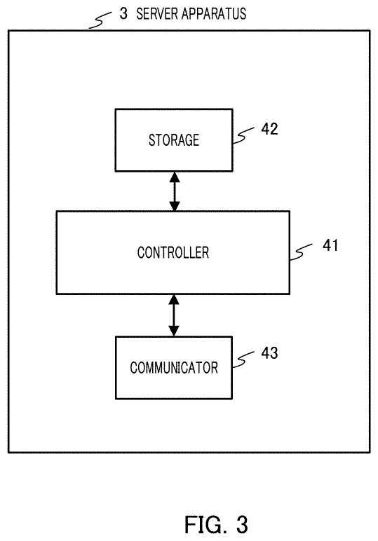

FIG. 3 illustrates an exemplary configuration of server apparatus 3.

As illustrated in FIG. 3, server apparatus 3 includes controller 41, storage 42, and communicator 43.

Controller 41 controls server apparatus 3. Controller 41 may be composed of a CPU.

Storage 42 stores therein a program for operation of controller 41. Storage 42 also stores therein data for calculation processing by controller 41, data for control of each section by controller 41, or the like. Storage 42 may be composed of a storage apparatus such as a RAM, a ROM, a flash memory, and an HDD.

Communicator 43 transmits/receives data to/from other apparatuses via network 6. For example, communicator 43 transmits data generated by controller 41 to network 6. Communicator 43 provides data received from network 6 to controller 41.

<Configuration of User Terminal>

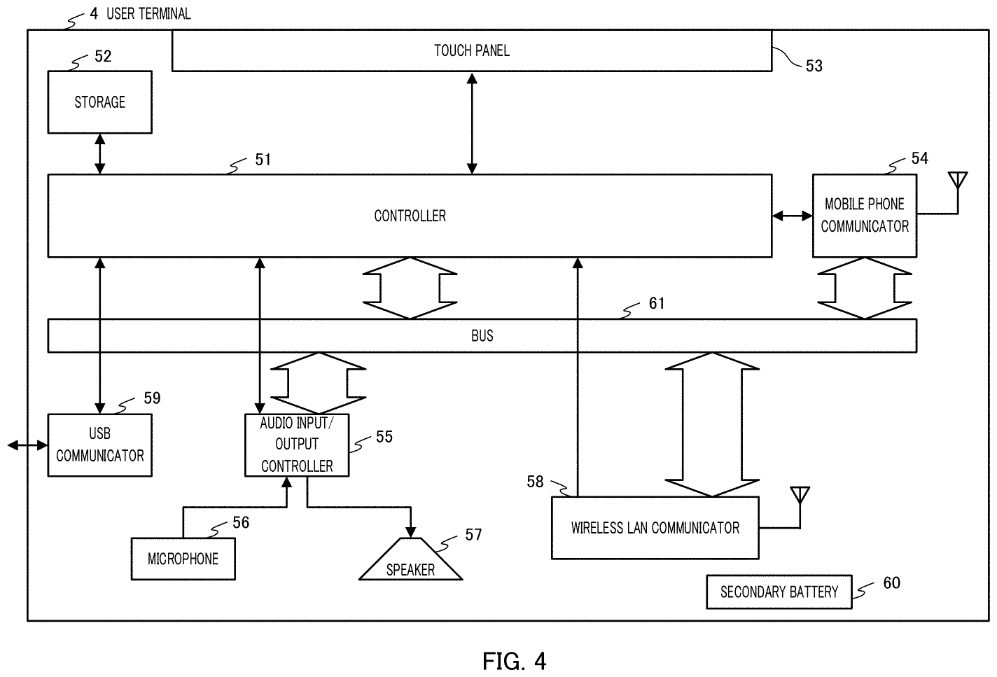

FIG. 4 illustrates an exemplary configuration of user terminal 4.

As illustrated in FIG. 4, user terminal 4 includes controller 51, storage 52, touch panel 53, mobile phone communicator 54, audio input/output controller 55, microphone 56, speaker 57, and wireless Local Area Network (LAN) communicator 58, Universal Serial Bus (USB) communicator 59, secondary battery 60, and bus 61.

Controller 51 controls user terminal 4. Controller 51 may be composed of a CPU.

Storage 52 stores therein a program for operation of controller 51. Storage 52 also stores therein data for calculation processing by controller 51, data for control of each section by controller 51, or the like. Storage 52 may be composed of a storage apparatus such as a RAM, a ROM, a flash memory, and an HDD.

Touch panel 53 is an apparatus that includes a display apparatus for displaying an image and a transparent plate-like input apparatus for receiving a user operation on a screen of the display apparatus. Touch panel 53 displays the image captured by monitoring apparatus 2. Touch panel 53 receives, for example, a tap operation, drag operation, or long press operation performed by a user, and outputs a signal corresponding to the received operation to controller 51.

Mobile phone communicator 54 is wirelessly connected to network 6 using wireless communication systems such as the third generation mobile communication system (3G), fourth generation mobile communication system (4G), and/or fifth generation mobile communication system (5G), for example. Mobile phone communicator 54 transmits/receives data to/from other electronic equipment via network 6.

Audio input/output controller 55, microphone 56, and speaker 57 perform audio input/output from or to the outside.

Wireless LAN communicator 58 is wirelessly connected to a router (not illustrated) using a wireless communication system such as Wi-Fi, for example. Wireless LAN communicator 58 transmits/receives data to/from other electronic equipment via the router.

USB communicator 59 transmits/receives data to/from equipment, memory, or the like having a USB standard interface.

Secondary battery 60 supplies necessary power to each section of user terminal 4. Secondary battery 60 is a rechargeable battery such as a nickel metal hydride battery, a lithium ion battery, a lead battery, or the like.

<Functions of Server Apparatus>

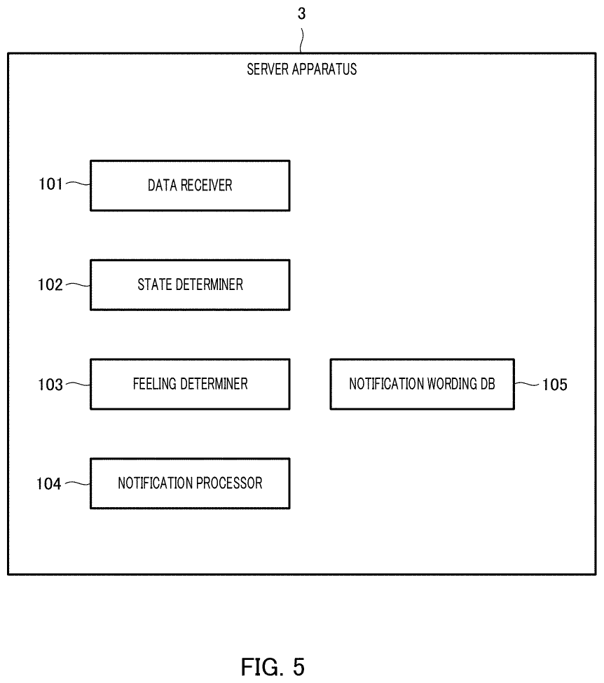

FIG. 5 illustrates exemplary functions of server apparatus 3.

Server apparatus 3 includes data receiver 101, state determiner 102, feeling determiner 103, notification processor 104, and notification wording DB 105.

«Data Receiver»

Data receiver 101 from monitoring apparatus 2 receives the image data and the audio data, which are one examples of sensor data. As described above, the image data may include the figure of a pet. The audio data may include a sound produced by the pet.

«State Determiner»

State determiner 102 determines the state of the pet on the basis of the image data and the audio data received by data receiver 101.

State determiner 102 analyzes the image data to determine a posture classification, which is one example of the state of the pet. Determination examples of the posture classification of the pet are described as follows:
When the image data includes the figure of the pet lying on his/her side, state determiner 102 determines that the posture classification of the pet is “lying on side”;
When the image data includes the figure of the pet standing on four legs, state determiner 102 determines that the posture classification of the pet is “standing on four legs”;
When the image data includes the figure of the pet standing on two legs, state determiner 102 determines that the posture classification of the pet is “standing on two legs”;
When the image data includes the figure of the pet turning his/her face upward, state determiner 102 determines that the posture classification of the pet is “turning face upward”;
When the image data includes the figure of the pet standing leaning forward, state determiner 102 determines that the posture classification of the pet is “leaning forward”;
When the image data includes the figure of the pet lying down with his/her head lifted, state determiner 102 determines that the posture classification of the pet is “lying down (with head lifted)”; and
When the image data includes the figure of the pet lying down with his/her head lowered, state determiner 102 determines that the posture classification of the pet is “lying down (with head lowered).”

State determiner 102 analyzes the image data to determine a facial expression of the pet, which is one example of the state of the pet. Determination examples of the facial expression of the pet are described as follows:
When the image data includes the face of the pet glaring, state determiner 102 determines that the facial expression of the pet is “glaring”;
When the image data includes the face of the pet opening his/her eyes wide, state determiner 102 determines that the facial expression of the pet is “opening eyes wide”; and
When the image data includes the face of the pet staring, state determiner 102 determines that the facial expression of the pet is “staring.”

State determiner 102 may perform the above determination using a deep neural network (DNN) that has deeply learned from a large amount of image data including the figures of pets.

State determiner 102 analyzes the audio data to determine the cry (produced sound) of the pet, which is one example of the state of the pet. Determination examples of the cry of the pet are described as follows:
When the pet is a dog, state determiner 102 analyzes the audio data to determine which of “bow-wow,” “grrr,” “awooo,” “yap yap,” “zzzz,” “gggg,” “growf,” “wrrr,” and “kmmm” the cry of the pet is; and
When the pet is a cat, state determiner 102 analyzes the audio data to determine which of “meow,” “hsss,” “prrr,” and “kkkk” the cry of the pet is.

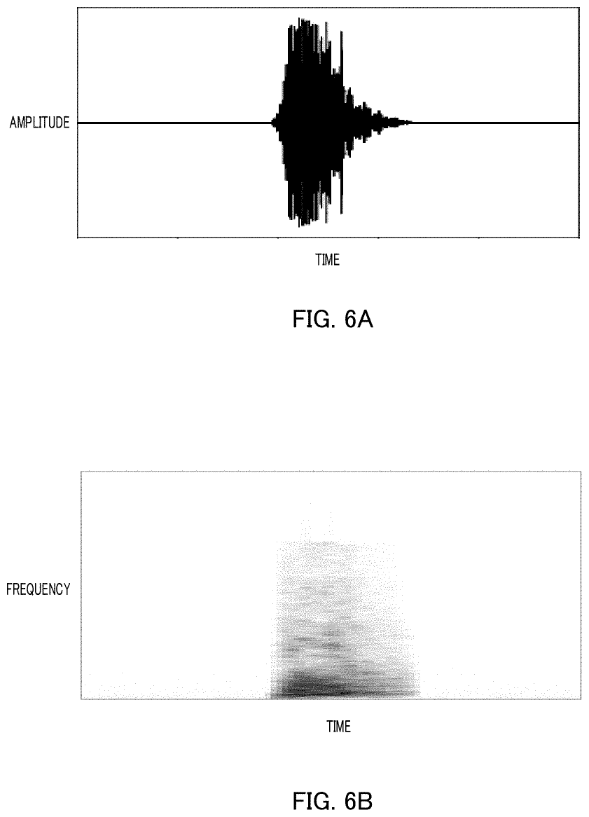

The audio data used for the analysis by state determiner 102 may be an audio signal including information about time and amplitude as illustrated in FIG. 6A. Alternatively, the audio data may be a spectrogram including information about time, frequency, and strength of a signal component as illustrated in FIG. 6B. State determiner 102 may also treat the spectrogram as the image data. This allows state determiner 102 to determine the audio data using the DNN as in the case of the image data including the figure of the pet.

State determiner 102 generates state information of the pet that is a combination of determination results of the posture classification, facial expression, cry, and the like described above. For example, state determiner 102 generates the state information that is a combination of the posture classification of “leaning forward/standing on two legs,” the facial expression of “glaring,” and the cry of “growf.”

Note that the audio data may also include, in addition to the cry of the pet, an environmental sound such as a chime sound. State determiner 102 may also analyze the audio data to determine the environmental sound. In this case, state determiner 102 may also generate the state information that is a combination further including the determined environmental sound.

In addition, the analysis based on the image data and/or the audio data are not limited to the above examples. For example, state determiner 102 may also analyze the location of the pet (toilet, feeding area, or the like) on the basis of the image data and/or the audio data.

«Notification Wording DB»

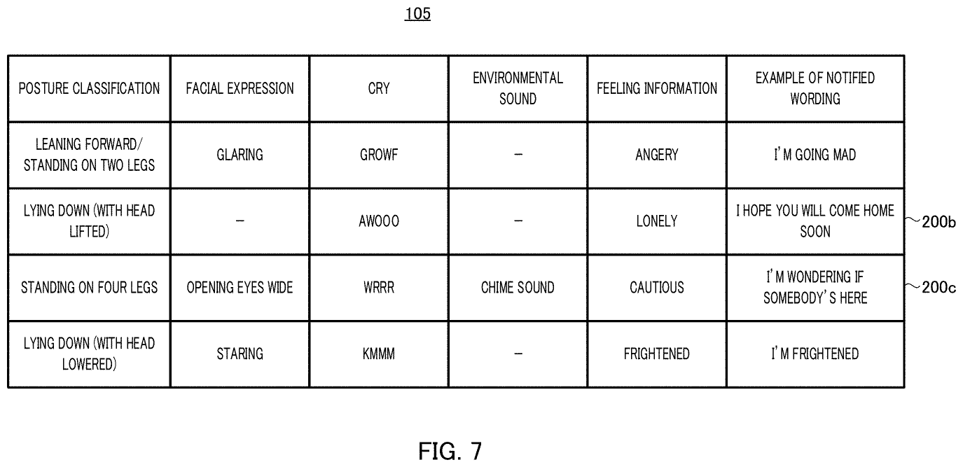

As illustrated in FIG. 7, notification wording DB 105 manages association between the feeling information and the combinations of the posture classifications, facial expressions, cries of the pet, and environmental sounds. Notification wording DB 105 also manages association between notification wordings and the feeling information. Note that FIG. 7 is one example, and notification wording DB 105 may also manage the association between the feeling information and at least one of the posture classification, facial expression, cry, and environmental sound illustrated in FIG. 7.

«Feeling Determiner»

Feeling determiner 103 determines the feeling information of the pet on the basis of the state information of the pet generated by state determiner 102. For example, feeling determiner 103 determines the feeling information of the pet on the basis of the state information of the pet using notification wording DB 105 illustrated in FIG. 7.

For example, when the state information is the combination of the posture classification of “lying down (with head lifted)” and the cry of “awooo,” feeling determiner 103 determines, with reference to row 200b of notification wording DB 105, that the feeling information is “lonely.” In addition, feeling determiner 103 identifies the wording, “I hope you will come home soon,” associated with the feeling classification of “lonely” with reference to row 200b of notification wording DB 105.

For example, when the state information is the combination of the posture classification of “standing on four legs,” the facial expression of “opening eyes wide,” the cry of “wrrr,” and the environmental sound of “chime sound,” feeling determiner 103 determines, with reference to row 200c of notification wording DB 105, that the feeling information is “cautious.” Furthermore, feeling determiner 103 specifies the wording, “I'm wondering if somebody's here,” associated with the feeling information of “cautious” with reference to row 200c of notification wording DB 105.

Feeling determiner 103 may also determine the feeling information of the pet using the DNN which, when a combination of pieces of state information of the pet is input, outputs the feeling information corresponding to the input.

«Notification Processor»

Notification processor 104 notifies user terminal 4 of the wording specified by feeling determiner 103, when a notification condition is satisfied. Notification processor 104 may notify of the image data together with the wording indicating the feeling of the pet.

The notification condition may be at least one of the following (A1) to (A4).

(A1) The notification is carried out when a time equal to or longer than a predetermined time has elapsed since the last notification. It is thus possible to notify user terminal 4 of the wording at an appropriate frequency.

(A2) The notification is carried out when the wording to be notified at the present time is different from the wording notified last time. It is thus possible to prevent continuous notifications of the same wording. It is also possible to notify of the wording when the feeling of the pet changes greatly.

(A3) The notification is carried out when an appropriate figure of the pet is included in the image data. It is thus possible to display the appropriate image data on user terminal 4. Note that, whether or not the appropriate figure of the pet is included may be determined on the basis of whether or not the image data includes the images of the eyes, nose, and/or mouth of the pet.

(A4) The notification is carried out when user terminal 4 is located outside the house where monitoring apparatus 2 is installed. It is thus possible to prevent notification of a wording when the user stays inside the house. Note that, whether user terminal 4 is located inside or outside the house may be determined on the basis of position information of user terminal 4, or may be determined on the basis of whether or not user terminal 4 and monitoring apparatus 2 are connected to the same LAN.

Note that, notification processor 104 may also generate the image data in which the wording is superimposed on the image including the figure of the pet, and notify user terminal 4 of the image data.

Notification processor 104 may also notify a server apparatus (not illustrated) of an SNS that the user uses. The server apparatus of the SNS transfers the notified wording to the SNS application in user terminal 4. It is thus possible for the user to receive the notification of the wording of the pet using the SNS application in user terminal 4. Note that the wordings may be displayed chronologically (that is, timeline display) on the screen of the SNS application.

<Operation of Server Apparatus>

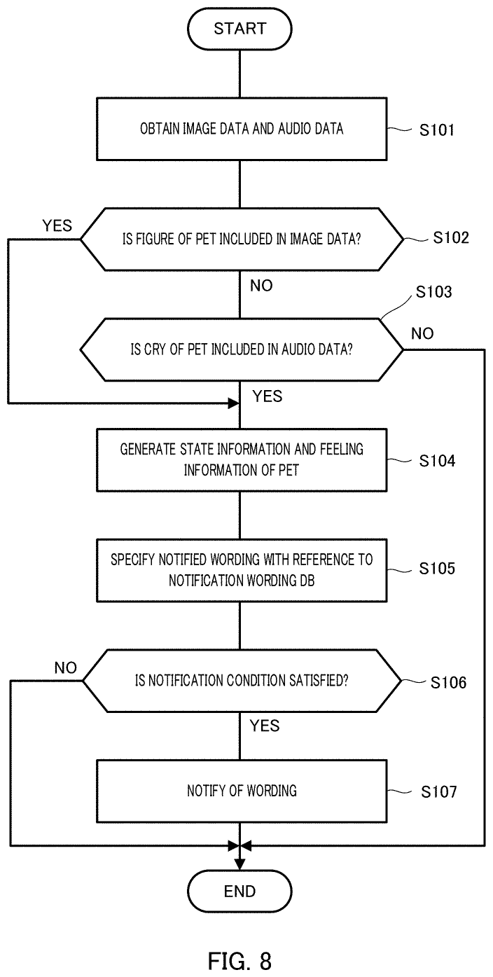

Next, an exemplary operation of server apparatus 3 will be described with reference to the flowchart illustrated in FIG. 8.

Data receiver 101 receives the image data and the audio data from monitoring apparatus 2 (S101).

State determiner 102 determines whether or not the figure of the pet is included in the image data received in S101 (S102). When the image data includes the figure of the pet (S102: YES), server apparatus 3 carries out the processing of 5104.

When the image data does not include the figure of the pet (S102: NO), state determiner 102 determines whether or not the audio data received in S101 includes the cry of the pet (S103). When the audio data does not include the cry of the pet (S103: NO), server apparatus 3 ends the processing (END). When the audio data includes the cry of the pet (S103: YES), server apparatus 3 carries out the processing of S104.

State determiner 102 generates the state information and the feeling information of the pet on the basis of the image data and/or the audio data (S104).

Feeling determiner 103 specifies, with reference to notification wording DB 105, the wording corresponding to the feeling information generated in S104 (S105).

Notification processor 104 determines whether or not the notification condition is satisfied (S106). When the notification condition is not satisfied (S106: NO), server apparatus 3 ends the processing (END).

When the notification condition is satisfied (S106: YES), notification processor 104 notifies user terminal 4 of the wording specified in S105 (S107). Server apparatus 3 then ends the processing (END).

<Modification>

Next, modifications of the above-described embodiment will be described. Note that the modifications described below may also be implemented in combination with one another.

The image data may also be moving image data. In this case, notification processor 104 may superimpose the wording specified by feeling determiner 103 on the moving image data received by data receiver 101 and transmit it to user terminal 4. The moving image data may be an image being captured by monitoring apparatus 2 in real time. Alternatively, the moving image data may also be an image captured and recorded in the past (that is, a recorded image) by monitoring apparatus 2.

When the image data includes the figures of a plurality of pets, state determiner 102 and feeling determiner 103 may set, as a determination target, one of the pets which is designated by user terminal 4.

When the image data includes the figures of a plurality of the pets, state determiner 102 and feeling determiner 103 may set, as the determination target, one of the pets which occupies the largest proportion of the image.

When the image data includes the figures of a plurality of pets, state determiner 102 and feeling determiner 103 may determine each of the pets as the determination target. In this case, at least one of the following (B1) and (B2) may be achieved.

(B1) Notification processor 104 may notify user terminal 4 of the wording of each of the pets. User terminal 4 may switch the wording to be displayed in accordance with an instruction by the user. In addition, when the user zooms in on a part of the image data, user terminal 4 may display the wording of the zoomed-in pet.

(B2) Notification processor 104 may transmit the set of the name and wording of each of the pets to user terminal 4. User terminal 4 may also display the received set of the name and wording of each of the pets. For example, user terminal 4 may display the name and wording of the pet of the same set side by side. By way of another example, user terminal 4 may display the names and wordings of pets of different sets in different colors.

(Embodiment 2)

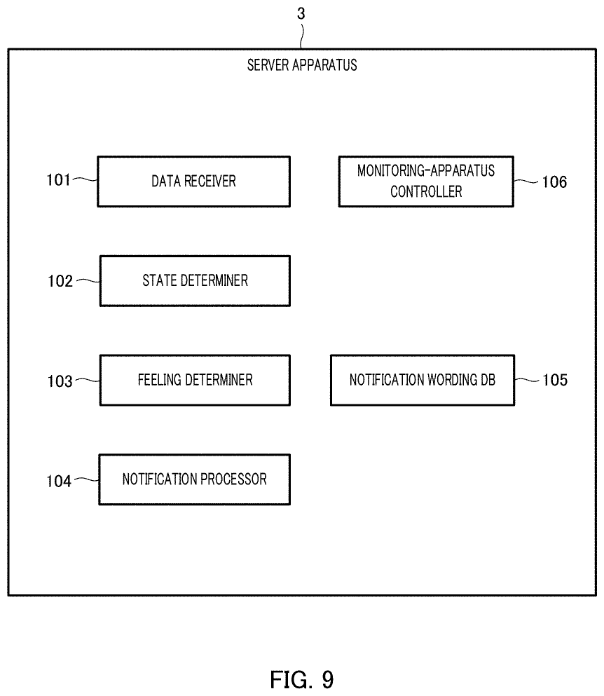

A description will be given of the functions of server apparatus 3 according to Embodiment 2 with reference to FIG. 9. Common descriptions among Embodiments 1 and 2 will be omitted in the description of Embodiment 2.

As illustrated in FIG. 9, server apparatus 3 according to Embodiment 2 further includes monitoring-apparatus controller 106. Monitoring-apparatus controller 106 controls monitoring apparatus 2 on the basis of an instruction from user terminal 4.

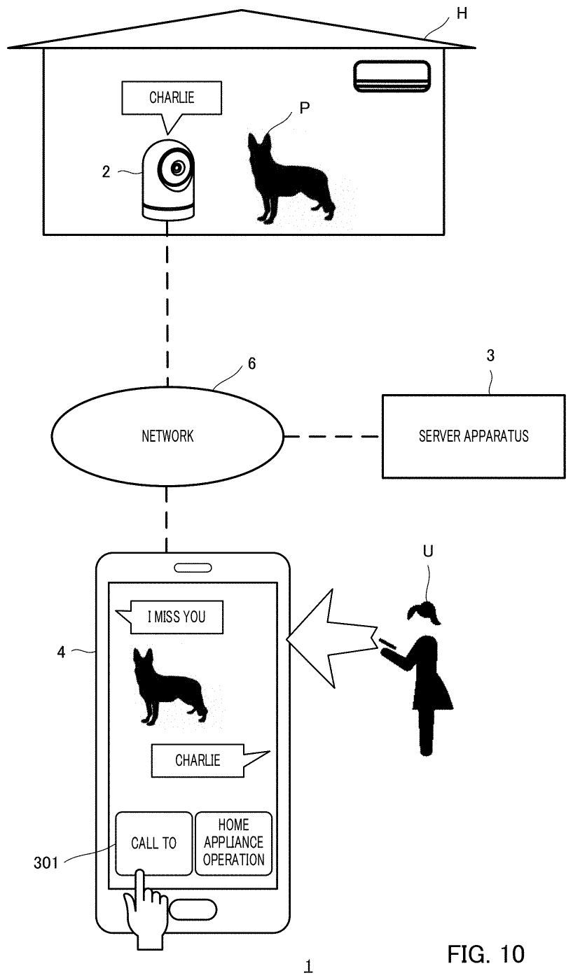

Next, processing example 1 of monitoring-apparatus controller 106 will be described with reference to FIG. 10. As illustrated in FIG. 10, user terminal 4 displays call button 301 together with the feeling information.

When user U presses call button 301, user terminal 4 transmits to server apparatus 3 information indicating that call button 301 has been pressed (hereinafter referred to as “call information”). When monitoring-apparatus controller 106 of server apparatus 3 detects reception of the call information, monitoring-apparatus controller 106 transmits a call instruction to monitoring apparatus 2. When monitoring apparatus 2 receives the call instruction, monitoring apparatus 2 outputs a sound corresponding to the received call instruction from speaker 29.

It is thus possible for user U to call to pet P through monitoring apparatus 2 in response to the wording of pet P of which user terminal 4 is notified.

Note that the calling method is not limited to pressing call button 301. For example, monitoring-apparatus controller 106 may also receive a voice uttered into user terminal 4 by user U and transfer the received voice to monitoring apparatus 2. Then, monitoring apparatus 2 may output the transferred voice from speaker 29.

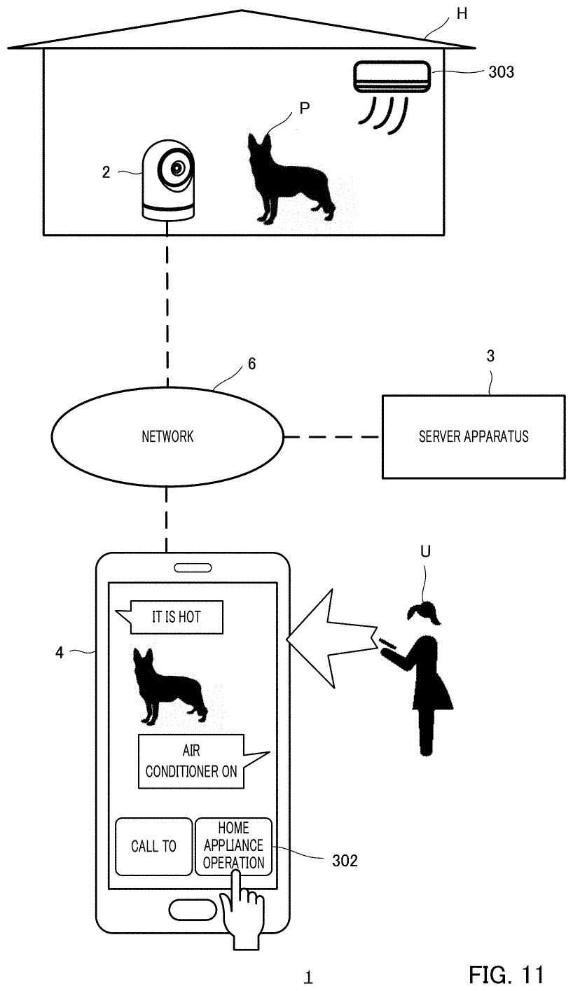

Next, processing example 2 of monitoring-apparatus controller 106 will be described with reference to FIG. 11. As illustrated in FIG. 11, user terminal 4 displays home appliance operation button 302 together with the wording.

When user U presses home appliance operation button 302, user terminal 4 transmits information indicating that home appliance operation button 302 has been pressed (hereinafter referred to as “home appliance operation information”) to server apparatus 3. When monitoring-apparatus controller 106 of server apparatus 3 detects reception of the home appliance operation information, monitoring-apparatus controller 106 transmits a home appliance operation instruction to monitoring apparatus 2. When monitoring apparatus 2 receives the home appliance operation instruction, monitoring apparatus 2 operates home appliance 303 in accordance with the received home appliance operation instruction.

It is thus possible for user U to operate home appliance 303 through monitoring apparatus 2 in response to the wording of pet P of which user terminal 4 is notified. For example, when user U is notified of the wording of the pet indicating that it is hot, user U performs the home appliance operation to turn on the air conditioner with user terminal 4. Accordingly, the air conditioner in the house is turned on, so that pet P can spend time comfortably.

(Embodiment 3)

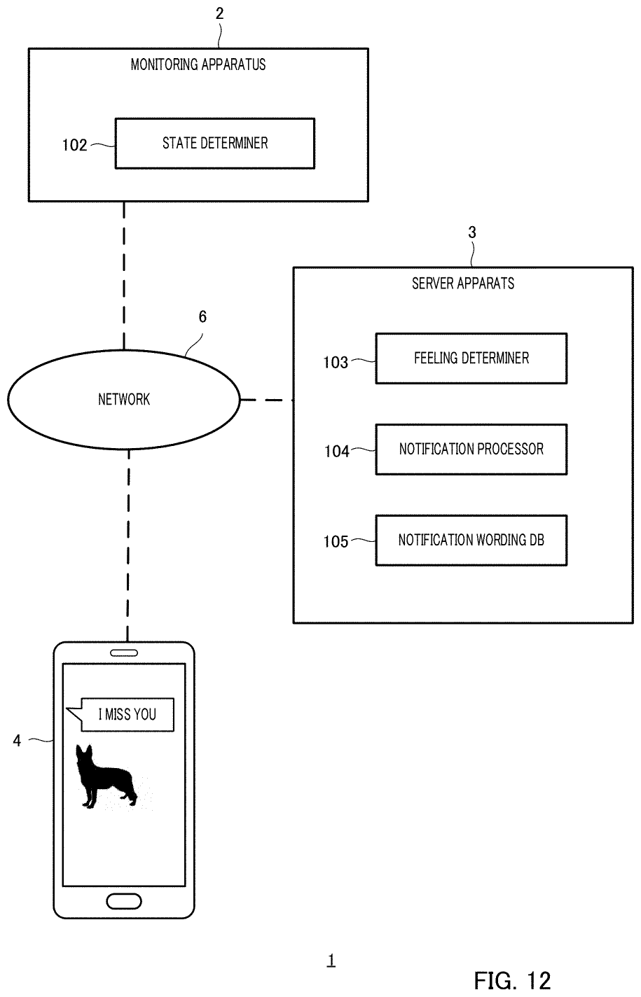

An exemplary configuration of an information processing system according to Embodiment 3 will be described with reference to FIG. 12. Common descriptions among Embodiments 1 and 3 will be omitted in the description of Embodiment 3.

As illustrated in FIG. 12, in the information processing system according to Embodiment 3, monitoring apparatus 2 includes state determiner 102, and server apparatus 3 includes feeling determiner 103, notification processor 104, and notification wording DB 105. In this case, state determiner 102 of monitoring apparatus 2 generates the state information of the pet and transmits the generated state information to server apparatus 3. Then, feeling determiner 103 of server apparatus 3 generates the feeling information on the basis of the state information received from monitoring apparatus 2.

According to the information processing system illustrated in FIG. 12, the processing of state determiner 102 is assigned separately to each monitoring apparatus 2, so that it is possible to reduce the processing load of server apparatus 3.

(Embodiment 4)

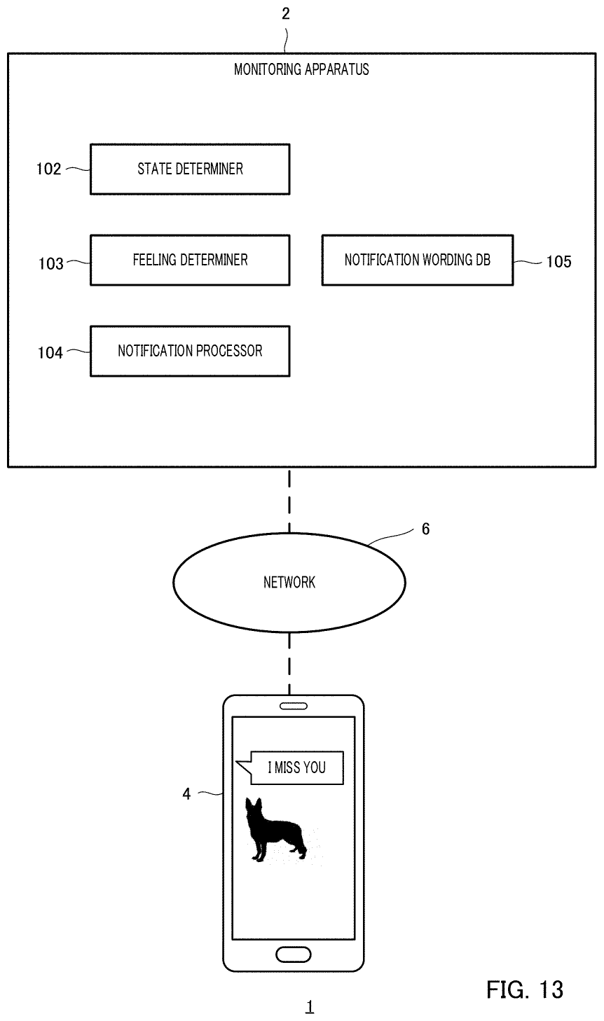

An exemplary configuration of an information processing system according to Embodiment 4 will be described with reference to FIG. 13. Common descriptions among Embodiments 1 and 4 will be omitted in the description of Embodiment 4.

As illustrated in FIG. 13, in the information processing system according to Embodiment 4, monitoring apparatus 2 includes state determiner 102, feeling determiner 103, notification processor 104, and notification wording DB 105. In this case, the information processing system does not have to include server apparatus 3.

According to the information processing system illustrated in FIG. 13, Embodiment 1 can be realized without using server apparatus 3.

(Embodiment 5)

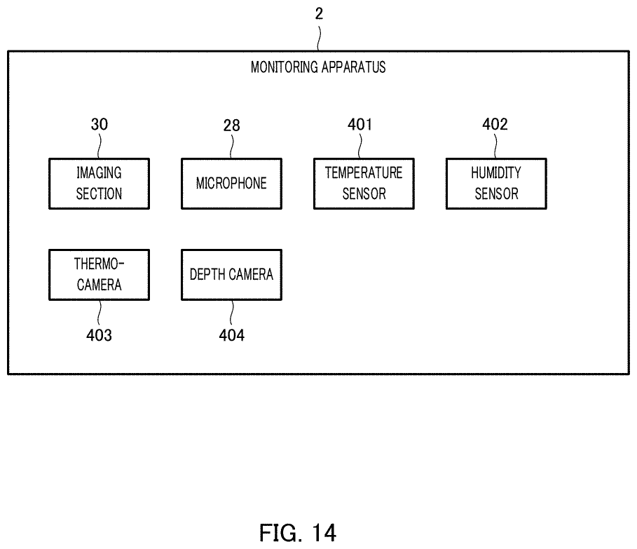

An exemplary configuration of an information processing system according to Embodiment 5 will be described with reference to FIG. 14. Common descriptions among Embodiments 1 and 5 will be omitted in the description of Embodiment 5.

As illustrated in FIG. 14, in the information processing system according to Embodiment 5, monitoring apparatus 2 includes at least one of the below-described components in addition to imaging section 30 and microphone 28. That is, monitoring apparatus 2 includes at least one of temperature sensor 401 that measures the temperature of the air, humidity sensor 402 that measures the humidity of the air, thermo-camera 403 that measures the body temperature of the pet, and depth camera 404 that is capable of measuring the distance to the pet. Imaging section 30 may also be a camera that is capable of capturing the image of the pet even in a dark place or at night (for example, a night vision camera or an infrared camera). Depth camera 404 may also be referred to as a Time-of-Flight (ToF) camera.

Monitoring apparatus 2 transmits, as sensor data, temperature data measured by temperature sensor 401, humidity data measured by humidity sensor 402, body temperature data of the pet measured by thermo-camera 403, and distance data of the distance to the pet measured by depth camera 404 to server apparatus 3 in addition to the image data and the audio data.

State determiner 102 of server apparatus 3 generates the state information on the basis of at least one of the image data, audio data, temperature data, humidity data, and body temperature data received from monitoring apparatus 2. Here, state determiner 102 analyzes, on the basis of the body temperature data, a vital sign of the pet that is one example of the state of the pet. For example, state determiner 102 analyzes the body temperature data to determine which of “rising,” “constant,” and “falling” the body temperature of the pet is. In this case, state determiner 102 generates the state information that is a combination of the posture classification, facial expression, cry, environmental sound, and vital sign. When a heart rate measurement sensor is attached to the pet, state determiner 102 may also analyze heart rate data received from the heart rate measurement sensor as an analysis of the vital sign of the pet. For example, state determiner 102 may determine which of “rising,” “constant,” or “falling” the heart rate of the pet is.

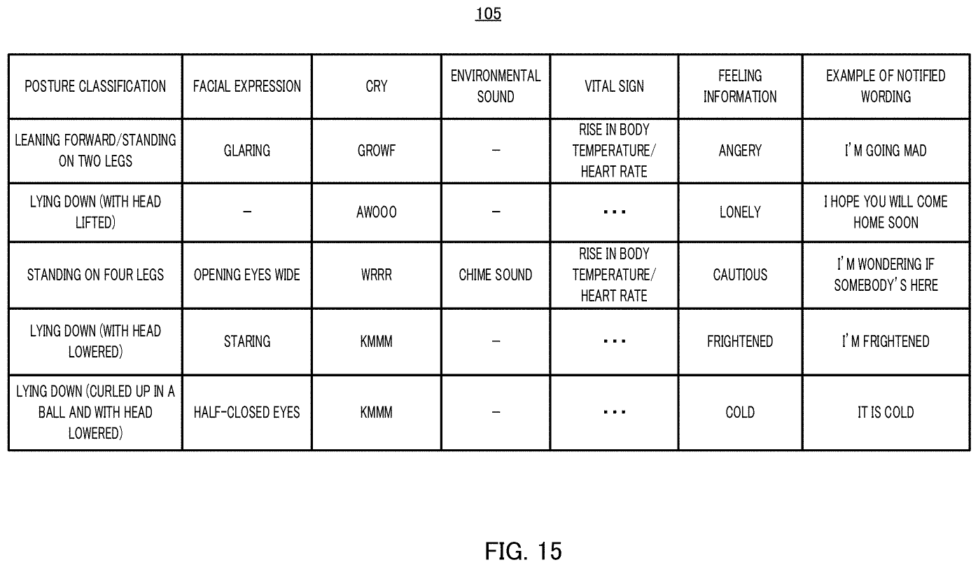

As illustrated in FIG. 15, notification wording DB 105 includes the vital sign as a combination item of state information in addition to the posture classification, facial expression, cry, and environmental sound.

Feeling determiner 103 determines the feeling information corresponding to the state information with reference to notification wording DB 105. That is, feeling determiner 103 determines the feeling information corresponding to the combination of the posture classification, facial expression, cry, environmental sound, and vital sign.

Accordingly, the information processing system according to Embodiment 5 is capable of notifying user terminal 4 of more various notifications than the information processing system according to Embodiment 1.

(Embodiment 6)

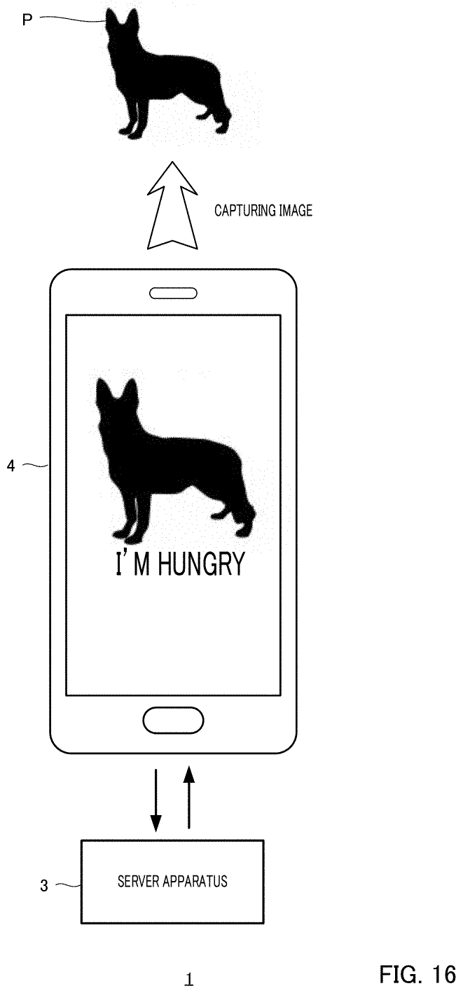

A description will be given of Embodiment 6 with reference to FIG. 16. Common descriptions among Embodiments 1 and 6 will be omitted in the description of Embodiment 6.

As illustrated in FIG. 16, user terminal 4 transmits to server apparatus 3 the image data of the figure of the pet captured and the audio data of the cry of the pet picked up. Server apparatus 3 processes the image data and audio data received from user terminal 4 in the same manner as in the case where the image data and audio data are received from monitoring apparatus 2 as described above. Then, server apparatus 3 transmits the notification wording to user terminal 4. User terminal 4 displays the wording received from server apparatus 3 such that the wording is superimposed on the pet being displayed on the screen.

It is thus possible for the user to know the feeling of the pet by pointing user terminal 4 toward the pet.

User terminal 4 may also include state determiner 102, feeling determiner 103, and notification wording DB 105. That is, user terminal 4 may generate the feeling information within itself without transmitting the image data of the figure of the pet captured and the audio data of the cry of the pet picked up to server apparatus 3. Then, user terminal 4 may superimpose and display the wording corresponding to the generated feeling information on the pet currently displayed on the screen.

### SUMMARY OF DISCLOSURE

Information processing system 1 according to the present disclosure includes: state determiner 102 that determines the state of an animal using a captured image of the animal; feeling determiner 103 that determines, on the basis of notification wording DB 105 that indicates the relationship between the state and the feeling of the animal, the feeling of the animal corresponding to the state of the animal determined by state determiner 102; and notification processor 104 that notifies user terminal 4 of the wording indicating the feeling of the animal determined by feeling determiner 103. Accordingly, the captured image of the animal is transmitted to server apparatus 3, and user terminal 4 is notified of the wording indicating the feeling of the animal. That is, it is possible to notify the user of the wording indicating the feeling of the animal without attaching any sensor apparatus to the animal.

State determiner 102 may determine, on the basis of the captured image of the animal, at least one of the posture and the facial expression of the animal as the state of the animal. With this configuration, the posture and facial expression of the animal are identified, so that it is possible to specify the feeling information corresponding to the identified classification, and notify the terminal of the wording corresponding to the specified feeling information.

State determiner 102 may also determine the state of the animal using the produced sound of the animal. In this case, the state determiner may determine, on the basis of the produced sound of the animal, the cry of the animal as the state of the animal.

Accordingly, the state of the animal is determined using the captured image of the animal and the produced sound of the animal, so that it is possible to notify of various wordings.

Notification processor 104 may notify of the wording of the present time when the wording to be notified at the present time is different from the wording notified last time. Accordingly, continuous notifications of the same wording are prevented, so that it is possible to notify of the wording at an appropriate frequency.

Notification processor 104 may notify of the captured image of the animal together with the wording. It is thus possible for the user to confirm the captured image of the animal and the wording together, so as to recognize the feeling of the animal more correctly.

Note that, the above-mentioned “pet” is one example of the animal. The embodiments described above are applicable to other animals than the pet, such as those kept at zoos or by livestock farmers.

In addition, all or part of the functions described above may be included in an information processing apparatus. The information processing apparatus may be any of monitoring apparatus 2, server apparatus 3, and user terminal 4 described above, or may also be an apparatus different from these.

Each functional block used for explaining the above-mentioned embodiments is realized as an LSI which is typically an integrated circuit. These functional blocks may be separately formed into individual chips, or may be formed into one chip to include all or some of these functional blocks. In this case, an appellation “LSI” is employed.

However, depending on the degree of integration, appellations such as IC, system LSI, super LSI, and ultra LSI may be employed.

In addition, the technique of circuit integration is not limited to the LSI, and it may be realized by a dedicated circuit or a general-purpose processor. A Field Programmable Gate Array (FPGA) that can be programmed after LSI fabrication or a reconfigurable processor that can reconfigure connections and settings of circuit cells inside the LSI may be used.

If future integrated circuit technology replaces LSIs as a result of the advancement of semiconductor technology or other derivative technology, the functional blocks could be integrated using the future integrated circuit technology. Biotechnology can also be applied.

### INDUSTRIAL APPLICABILITY

The present disclosure is useful for an information processing system.

### REFERENCE SIGNS LIST

1 Information processing system

2 Monitoring apparatus

3 Server apparatus

4 User terminal

6 Network

21 Controller

22 Storage

23 Operation section

24 Pan motor

25 Tilt motor

26 Infrared sensor

27 Audio input/output controller

28 Microphone

29 Speaker

30 Imaging section

31 Video memory controller

32 Video memory

33 Wireless LAN communicator

34 Power supply

35 External memory I/F section

36 Bus

41 Controller

42 Storage

43 Communicator

51 Controller

52 Storage

53 Touch panel

54 Mobile phone communicator

55 Audio input/output controller

56 Microphone

57 Speaker

58 Wireless LAN communicator

59 USB communicator

60 Secondary battery

61 Bus

101 Data receiver

102 State determiner

103 Feeling determiner

104 Notification processor

105 Notification wording DB

106 Monitoring apparatus controller

1. An information processing apparatus, comprising:
a state determiner that determines a state of an animal using a captured image of the animal;
a feeling determiner that determines a feeling of the animal corresponding to the state of the animal determined by the state determiner, the feeling determiner determining the feeling of the animal on a basis of information indicating a relationship between the state and the feeling of the animal; and
a notification processor that notifies a terminal of a wording indicating the feeling of the animal determined by the feeling determiner.

2. The information processing apparatus according to claim 1, wherein
the state determiner determines, on a basis of the captured image of the animal, at least one of a posture and a facial expression of the animal as the state of the animal.

3. The information processing apparatus according to claim 1, wherein
the state determiner determines the state of the animal using a produced sound of the animal.

4. The information processing apparatus according to claim 3, wherein
the state determiner determines, on a basis of the produced sound of the animal, a cry of the animal as the state of the animal.

5. The information processing apparatus according to claim 1, wherein
the notification processor notifies of the wording when the wording is different from a wording notified last time.

6. The information processing apparatus according to claim 1, wherein
the notification processor notifies of the captured image of the animal together with the wording.

7. An information processing method, comprising steps performed by an information processing apparatus of:
determining a state of an animal using a captured image of the animal;
determining a feeling of the animal corresponding to the determined state of the animal on a basis of information indicating a relationship between the state and the feeling of the animal; and
notifying a terminal of a wording indicating the determined feeling of the animal.
